(19) United States
(12) Patent Application Publication
(10) Pub. No.: US 2015/0172518 A1
(43) Pub. Date: Jun. 18, 2015

(54) MONITORING SYSTEM AND METHOD INCLUDING SELECTIVELY MOUNTABLE WIRELESS CAMERA

(71) Applicant: Convoy Technologies, LLC,, Newport Beach, CA (US)

(72) Inventors: Martin Lucas, Rancho Santa Margrita, CA (US); Iulia Lidia Palu, Rye, NY (US); Blake Albert Gaska, Aliso Viejo, CA (US)

(21) Appl. No.: 14/517,689

(22) Filed: Oct. 17, 2014

Related U.S. Application Data
(60) Provisional application No. 61/916,053, filed on Dec. 13, 2013.

(51) Int. Cl. H04N 5/225; H04N 5/232; B60R 1/00; H04N 7/18

(52) U.S. Cl. CPC H04N 5/2251; H04N 7/183; H04N 5/23293; B60R 1/00; B60R 2300/406; B60R 2300/806; B60R 2300/8066; B60R 2300/808; B60R 2300/802

(57) ABSTRACT

Test system and method comprise battery powered wireless camera for tractor-trailer vehicles and/or unmarried vehicles on road. Removable (magnetic) camera unit can be selectively mounted on trailer and provide image, video and audio monitoring solution to better assist drivers overcome blind spots around tractors and trailers. Wireless camera system includes one or more camera-containing units that can be attached to any trailer, in nonpermanent manner, using magnets and powered by battery enclosed in a single housing where camera is located. Camera unit can provide real time infrared, night vision, video and/or audio to tractor cab through generic or dedicated monitor located in cab. Crosstalk between camera-containing units is mitigated by individually pairing each camera unit with a monitor/receiver at any given time and using appropriate communication protocols. Camera-containing unit can include solar panel, can be permanently mounted, and can be recharged using photovoltaic cells.

### CROSS-REFERENCE TO RELATED APPLICATION

This application claims benefit under 35 U.S.C. §119(e) of U.S. provisional patent application Ser. No. 61/916,053 filed Dec. 13, 2013, the disclosure of which is hereby incorporated by reference in its entirety.

### BACKGROUND OF THE INVENTION

1. Field of the Invention

Generally, the present invention is in the field of video monitoring test systems for vehicles, and more specifically relates to wireless video monitoring system and method for tractor-trailer vehicles as well as unmarried vehicles on the road.

2. Discussion of the Background of the Invention

Tractor-trailers are among the largest vehicles that operate on the same roads with passenger vehicles, which requires maneuvering tractor-trailers in very tight spaces at the delivery destinations, along highways or parking structures. Due to their size and the large amount of deliveries they make, tractor-trailers are susceptible to accidents. Improving visibility for tractor-trailer drivers can mitigate these incidents.

Conventionally, backup video cameras are available for permanent mounting at the rear of a vehicle with a permanent connection to a power source available, for example via the same power line that supplies power from the vehicle's battery to a rear break light. Similarly, on a tractor-trailer it would be desirable to have a camera positioned relative to the trailer to improve driver rear view, or cornering visibility. However, most trailers (more than 90%) do not have power sent from the tractor, tractor usually operates different trailers, and tractor and trailer are not permanently connected to each other. Therefore, it is very difficult, impossible, and/or impractical to run cables between the cab of a tractor and the trailer, where a camera can be advantageously positioned, to communicate with and power the camera.

### SUMMARY OF THE INVENTION

Exemplary embodiments of the present invention address at least the above problems and/or disadvantages and provide at least the advantages described below.

Exemplary embodiments of the present invention provide systems and methods including a battery powered wireless camera, which can be configured for tractor-trailer vehicles and/or unmarried vehicles applications.

An exemplary implementation of a camera system according to the embodiments of the present invention provides a removable camera and monitoring equipment to better assist drivers overcome blind spots around their tractors and trailers.

In further exemplary implementations of the present invention, magnetic components can be provided to removably attach a housing of a camera-containing unit, for example to a trailer.

An exemplary embodiment of the present invention provides a monitoring device comprising magnetic components and a rechargeable wireless camera contained in a weatherproof housing that can be attached to any part of a trailer and provide daytime, and for example infrared, night vision, video, and/or audio to a dedicated or a generic monitor, for example remotely disposed in a cab of a tractor.

According to exemplary implementation of the present invention, wireless communication from a camera-containing unit is configured to avoid crosstalk with other sources of wireless communication, such as other camera-containing units, by individually pairing a camera-containing unit with a monitor/receiver at any given time.

According to yet another exemplary embodiment of the present invention, a camera-containing unit can include a solar panel as a power source. In still another exemplary embodiment of the present invention a camera-containing unit rechargeable using photovoltaic cells can be configure for optional permanent mounting.

Exemplary embodiments of the present invention provide systems and methods utilizing a controller, which can be microprocessor derived and include an operating system for programmability to control, for example, signals output from camera-containing units.

Yet further exemplary implementations of the present invention provide systems and methods utilizing a user interface, including without limitation GUI and/or voice-controlled interface, to control display of video, images and/or audio signals output from camera-containing units.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIGS. 1A, 1B and 1C are generalized block diagrams illustrating multiple views of a camera-containing unit according to an exemplary embodiment of the present invention.

FIG. 2 illustrates an exemplary interconnection of components and configurations for implementing structure, methodology and functionality in accordance with exemplary embodiments of the present invention.

FIG. 3 illustrates an example of components and configuration thereof in a housing structure for implementing methodology and functionality in accordance with exemplary embodiments of the present invention.

FIG. 4 is a generalized diagram illustrating an example of signal paths and system components according to exemplary embodiments of the present invention.

FIG. 5 is a mechanical drawing illustrating an exemplary implementation of an antenna for wireless communication according to exemplary embodiments of the present invention.

FIG. 6 is mechanical diagram illustrating an exemplary implementation of an indicator light structure, for example including a Light Emitting Diode (LED), according to exemplary embodiments of the present invention.

FIGS. 7A and 7B are mechanical drawings illustrating an exemplary implementation of a charging connector structure, such as a jack, according to exemplary embodiments of the present invention.

FIGS. 8A, 8B, and 8C conceptually illustrate a display and user interface of a monitoring component according to exemplary embodiments of the present invention.

FIGS. 9A, 9B, and 9C conceptually illustrate video signal pairing and transmission according to exemplary embodiments of the present invention.

FIGS. 10A, 10B, 10C and 10D are mechanical drawings illustrating multiple views of an exemplary implementation of housing structure for a camera-containing unit according to exemplary embodiments of the present invention.

FIG. 11 is a three-dimensional drawing illustrating a camera-containing unit according to an exemplary embodiment of the present invention.

### DETAILED DESCRIPTION OF EXEMPLARY EMBODIMENTS

Referring now to the drawings, wherein like reference numerals designate identical or corresponding parts throughout the several views, embodiments of the present invention are shown in schematic detail.

The matters defined in the description such as a detailed construction and elements are nothing but the ones provided to assist in a comprehensive understanding of the invention. Accordingly, those of ordinary skill in the art will recognize that various changes and modifications of the embodiments described herein can be made without departing from the scope and spirit of the invention. Also, well-known functions or constructions are omitted for clarity and conciseness. Certain exemplary embodiments of the present invention are described below in the context of commercial applications, or with reference to drawings containing certain numerical values for illustrating examples of dimensional relationships between parts shown therein. Such exemplary implementations are not intended to limit the scope of the present invention, which is defined in the appended claims.

Exemplary embodiments of the present invention provide a battery powered wireless camera unit designed for tractor-trailer vehicles and/or unmarried vehicles on the road. Systems and methods according to exemplary embodiments of the present invention comprise a removable (for example, magnetically mountable) camera and monitoring solution to better assist drivers overcome the blind spots around their tractors and trailers.

According to an exemplary embodiment of the present invention, a wireless camera system can be attached to any trailer, in a nonpermanent manner, using magnets and powered by a battery enclosed in a single housing where the camera is located. Conventionally, while a driver is backing into a loading dock or driving in a populated parking lot/structure, a spotter is often required in addition to carefully configured mirrors to ensure successful maneuvering of the tractor-trailer. Exemplary embodiments of the inventive system and method provide magnetic, rechargeable, wireless camera-containing unit that can be attached to essentially any part of the trailer and provide immediate infrared, night vision, or daytime video (as needed) to a driver through an existing or a dedicated monitor located in the cab. The monitor can be uniquely paired with the camera to address potential crosstalk with other cameras. Rechargeable battery of the camera-containing unit can be recharged by conventional means, or a solar panel can be added. In a solar-powered system, camera-containing unit can be permanently mounted and recharged using photovoltaic cells.

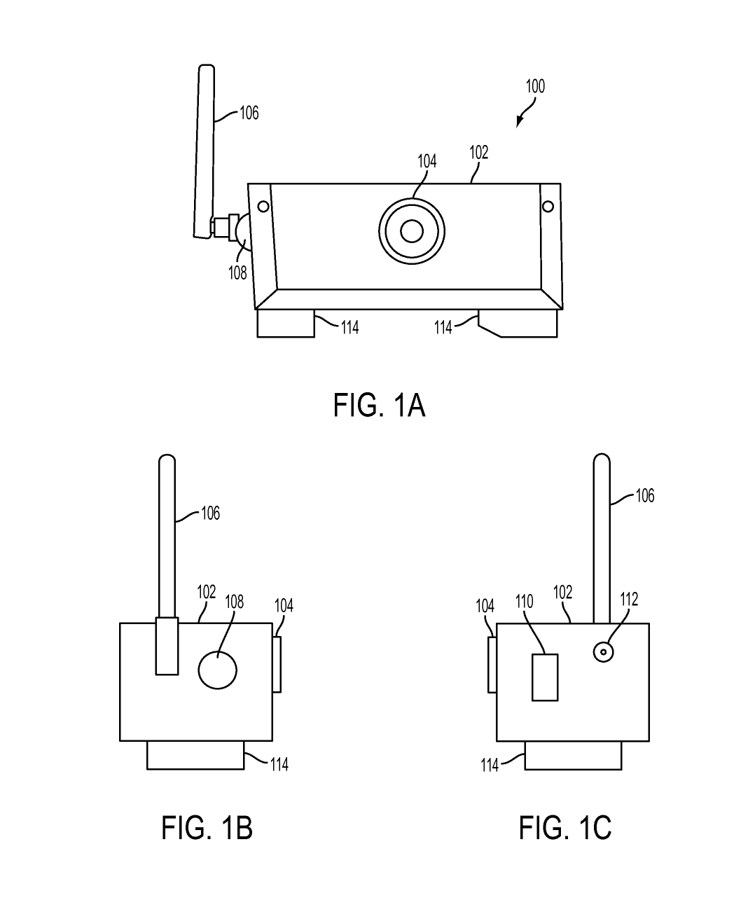

Referring to a general block diagram of FIG. 1, a camera-containing unit 100 according to an exemplary embodiment of the present invention includes housing 102, camera 104, wireless communication antenna 106, pairing button 108, power switch 110, power jack 112, and mounting structures 114. According to an exemplary implementation of embodiments of the present invention, mounting structures 114 can comprise two magnets (for example, approx. 5 mm deep), one disposed on bottom (for, example 90 degrees from the side that includes the camera) and another on back (for example, parallel with the camera side) of a rectangular housing 102 of camera-containing unit 100, and have the following non-limiting specifications:
Dimensions 50×25×10 mm w/holes
Tolerances 0.05 mm
Material NdFeB, Grade N42
Plating/Coating Zinc
Max Operating Temperature: ˜80
Brmax ˜14200 Gauss
Bhmax ˜53.5 MGOe
Intrinsic Coercive force (iHc) ˜12000 Oe
Center Field ˜4300 Gs
Thickness ˜7.4-7.5 g/m³
Magnetization: Direction Thru Thickness
Pull Force, Case 1 70 lbs

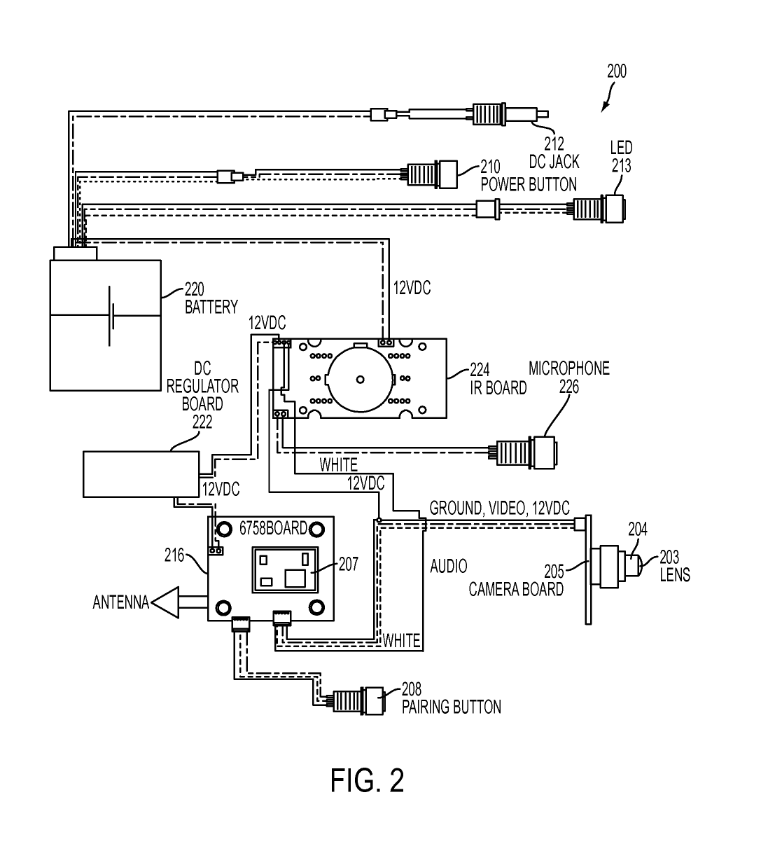

Referring to a component diagram of FIG. 2, a camera-containing unit 200 according to an exemplary embodiment of the present invention includes camera circuit board 205, communication (TX) processing circuit board 206, infrared (IR) processing circuit board 224, DC regulator circuit board 222, and battery 220. In the example of FIG. 2, supply voltage for the circuits illustrated is 12V DC provided by battery 220, which can be a rechargeable battery, for example chargeable using a power source connected via DC jack 212. DC regulator 222 facilitates appropriate DC voltage supply to circuit components of camera-containing unit 200. A power button or switch 210 can be provided for manual ON/OFF control of camera-containing unit 200. An indicator light 213, which may include an LED light source, can be provided to visually indicate operation of camera-containing unit 200. In an exemplary implementation, indicator light can be programmed to provide indication of different aspects of operation of camera-containing unit 200, for example by continuous illumination, selective blinking, or selective variable color output corresponding to one or more operations such as ON/OFF status, pairing status, video output, image output, and/or audio output.

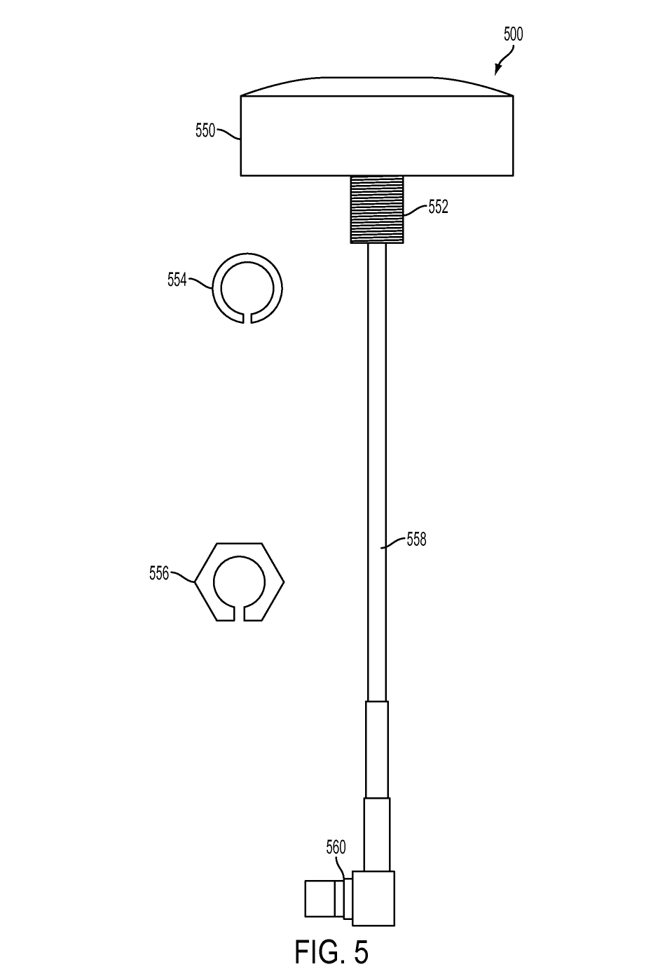

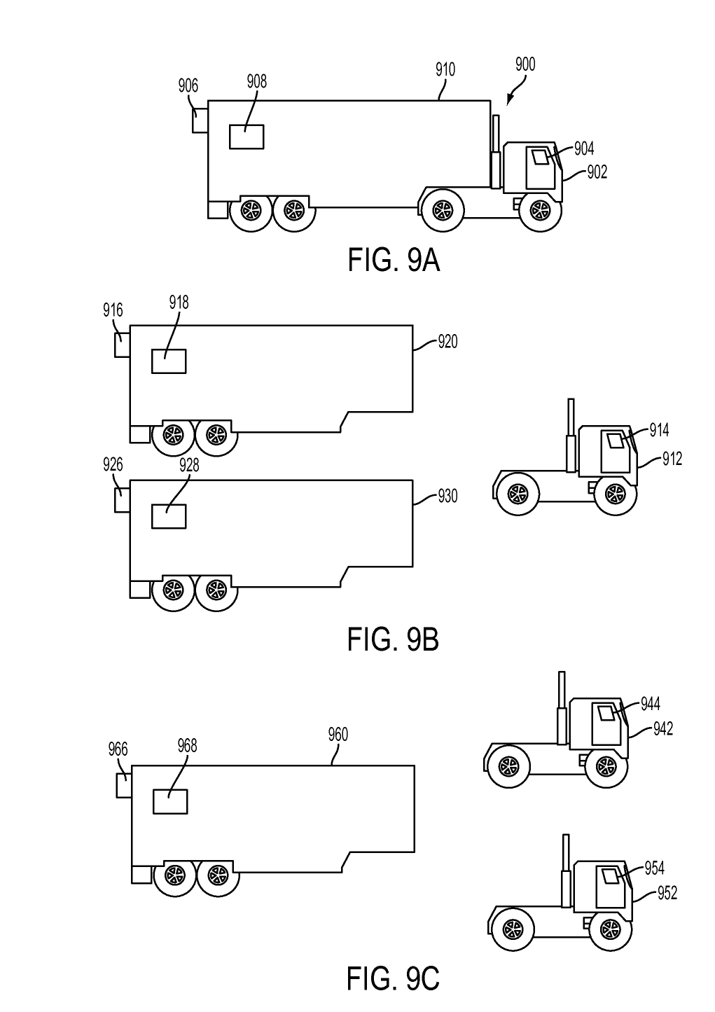

According to an exemplary implementation of embodiments of the present invention, TX circuit board 206 includes one or more microprocessors 207 and is configured to process signals received and transmitted by a connected antenna, such as wireless communication antenna 106 illustrated in FIG. 1A or FIG. 5 (described in more detail below). In a further exemplary implementation of the present invention, pairing button 208 allows to manually initiate a wireless pairing function between camera-containing unit 200 and a monitor, such as monitor 900 or 910 of FIGS. 9A and 9B (described in more detail below), in wireless communication with the camera-containing unit 200. Exemplary non-limiting specifications for a wireless transmitter, TX board and image capture according to an embodiment of the present invention are as follows:
Multi-format MPEG encoder (MPEG Encoder format specification)
   MPEG4 encoder
      30 fps at 720×480, 25 fps at 720×576
   H.263 encoder:
   JPEG encoder
   Video pre-processing
Multi-format MPEG decoder (MPEG Decoder format specification)
30 fps at 720×480, 25 fps at 720×576
   H.263 decoder:
   JPEG decoder
   Video post-processing
Video capture input and LCD output interface (Video/Audio Signal Input & Output Interface)
   Video Capture interface
      CCIR656 for external TV decoder
      Raw RGB for CMOS/CCD sensor
   LCD Output interface
   CCIR656 for LCD panel
   8 bits series RGB of LCD panel
TV out (Video out supporting CVBS Format which is what we are using)
LCD controller (Can be supported with embedded LCD solution)
High speed serial programming interface (SPI) for companion RF chip. (SPI is interface use for connecting their RF sub-module)
Power Management Control (Build-in PM module to handle energy saving control)

| | |
|---|---|
| RF 2.4 GHz technology (POWER | +5~+12 V |
| SUPPLY) | |
| TX (Current Consumption) | TYPE: 330 mA, Max.400 mA |
| RX (Current Consumption) | 200 mA |

Environmental Specification)

| | |
|---|---|
| Operating Temperature) | −10~+60° C. |
| Storing Temperature) | −30~+85° C. |
| Operating humidity) | 85% RH |

BASEBANGD SPEC.)

| | |
|---|---|
| POWER ON) | 2 SEC Max. RE |
| | TBD Max. SE/AV |
| Latency) | 100 ms Max. RE |
| | TBD Max. SE/AV |
| Resolution) | VGA/640 × 480 RE |
| | PAL: 720 × 576/NTSC: 720 × 480 SE/ |
| Frame Rate) | AV 30 f/s |
| | NTSC: 30 f/s/PAL: 25 f/s SE/AV |
| Video Codec | MPEG4 |
| TX (Video in System) | PAL/NTSC Auto detection |
| RX (Video out System) | PAL/NTSC Auto detection |
| Audio Codec) | MP3 1 Channel |
| (Voice Sample Rate) | 8 KHz M RE/SE |
| | 48 KHz AV |
| (Voice Frequency Band) | 340 Hz~3.4 KHz RE/SE |
| | 20 Hz~20 KHz AV |
| (ID)/(BIT) | Pairing)/22(4KK) |
| (SYSTEM Architecture) | ARM9(32 Bit) SOC |

(RF SPEC.)

| | |
|---|---|
| (Operation Frequency) | 2400~2483.5 MHz* |
| (RF Impedance) | 50 Ω, Typ. |

According to exemplary implementations of embodiments of the present invention, TX board 206 includes a highly integrated System On Chip (SOC) platform, for example with a high-speed 32-bit ARM926 CPU core for embedded applications and a hardwired multi-format MPEG encoder/decoder for video acceleration as well as a variety of interfaces which are suitable for digital audio/video application. In a further exemplary implementation, TX board 206 comprises NOR flash controller, SDRAM controller, USB OTG controller, DMA controller and smart power saving mechanism as part of SOC platform. Exemplary implementations provide interfaces like video capture, LCD controller, TV encoder with 1-channel DA, audio AD/DA with digital filters, I2S, SPI are very suitable for audio/video applications.

According to further exemplary implementations of embodiments of the present invention, TX board 206 includes is a 2.4 GHz ISM band HDR (high data rate) FH (frequency hopping) transceiver. In an exemplary implementation, such a device comprises a single chip solution with integrated MAC, BBP and RF for wireless application operating in 2.4 GHz band. For example, three types of digital modulation 16QAM/QPSK/BPSK, and on-air data rate support 12 Mbps/6 Mbps/3 Mbps, can be provided. Exemplary implementations can further provide 80 overlay channels, where each channel can be independently enable or disable with hopping table. For example, enabling one channel with hopping table setting transceiver can operate at fixed frequency, or enabling several channels with hopping table setting transceiver can operate as FH transceiver to reduce co-channel interference. Using smart interference detection algorithm hopping table can be updated by SPI digital interface, and this feature allows RTC6763 to avoid other interferences in 2.4 GHz band.

According to another example, transceiver with TDD (Time Division Duplex) functionality can create a centralized network with one master to coordinate up to four slaves. The system can operate in single mode (1 master with 1 salve) or multiple display modes (1 master with up to 4 slaves). Mode switching can be performed on the fly.

According to further exemplary implementation of embodiments of the present invention, TX board 206 can be configured for improving heat dissipation and eliminating image drop at elevated temperatures, as follows:
Moving 12V to 5V DC to DC regulation to separate power board.
Changing the TX board to 5 VDC input.
Providing board layout for more efficient thermal transfer from the chip to PCB
Providing board layout for more efficient thermal conduction between the PCBA and enclosure.
Changing L10 from BEAD to 27R to solve image drop problem
Changing R10 from 4.7K to 10K to improve startup stability
Adding resistor to change CPU to run at 120 MHz clock. (20 mA@5 VDC current reduction)
Adding 3 more resistors to reserve performance tuning capability with system clock adjustment.
Changing bootloader firmware to shut down unnecessary on-chip circuitry.

Further, in an exemplary implementation of the present invention, camera circuit board 205 receives and processes signals from camera 204 including lens system 203 for further processing, as may be required, and transmission by circuit 206. In an exemplary implementation of the present invention, circuit board 205 can also control camera 204 using control signal received, for example via wireless communication, and processed using circuit board 206. The control of camera 204 can include for example and without limitation: zoom, angle, focus, lighting, resolution, as well as other aspects of camera control depending on selected camera functionality, as would be appreciated by one skilled in the art of video camera imaging. Exemplary non-limiting specifications for a camera and image processing according to an embodiment of the present invention are as follows:
Sensor: ⅓″ HAD color camera
Resolution (pixel): 967×494
Lens: f=2.8 mm
Lens angle: 90° Horizontal; 65° Vertical
Mini-Illumination: OLux (LED ON)
IR LED: 12 pcs
IR switch: available
Night Vision Distance: 36 ft.
Video format: NTSC
Audio: available
2.4 GHz RF Technology
Transmitting Distance: min. 90′ barrier free
Voltage: 12V
Battery: 3s2p 18650 Lithium Ion rechargeable
Operating temperature: 0 to 65 C
Timer: 15 minutes time off, can be re-started by pressing the power button
LED Red: Low battery indicator (Need to charge the battery)
LED Green: Battery charged
Pairing indicator (flashes when paired, constant green light when successfully paired)
DC Port for charger
Magnets on the back and bottom of camera-containing unit for removable mounting
Waterproof: IP65
Enclosure material: Aluminum Alloy
Dustproof, waterproof, protection against hydrochloric acid
Dimensions: 97(W)×82(H)×140(L) mm

Still further, in an exemplary implementation of the present invention, IR circuit board 224 provides additional functionality of infrared image processing. In yet another exemplary implementation of certain embodiments of the present invention, microphone 226 can be provided to receive audio input for transmission via wireless communication provided by TX board 206 and antenna connected thereto. Audio output can be independent of, or for example essentially simultaneous with, the video or images received via camera 204. Exemplary non-limiting specifications for an IR board according to an embodiment of the present invention are as follows:
Microphone (12V, 500 uA)
IR board: (12V, 80 mA)
Camera board, IR Board use in C1800AHD
Input Voltage Range: Vmin ˜9V, Vnom ˜10V, Vmax ˜11V
Input Current Range: Imin ˜10 mA, Imax ˜120 mA
Operating Temperature Range ˜−20° C. to ˜+70° C.
Storage Temperature Range ˜−30° C. to ˜+75° C.
Light Sensitivity (Resistant ˜30 to −50 KΩ)
Microphone Sensitivity ˜−58 dB to ˜−54 dB

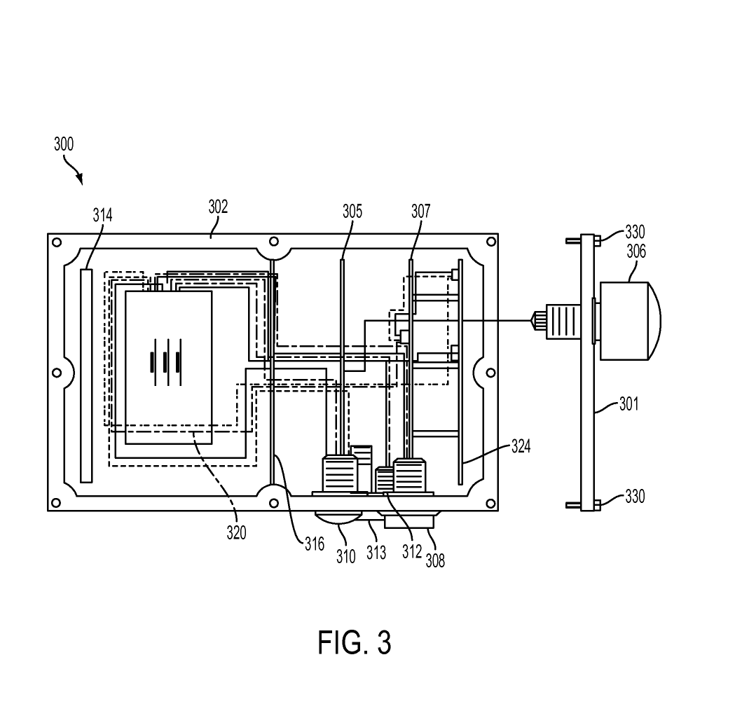

Referring to FIG. 3 according to an exemplary embodiment of the present invention components of a camera-containing unit 300 can be arranged within housing 302 to facilitate proper cooling of the included circuit components and reception/transmission of wireless signals via antenna 306. For example, battery 320 or 220 can be disposed in proximity of magnetic mounting structure 314, while the circuit boards including TX board 306 or 206, camera board 305 or 205, IR board 324 or 224, and other circuit boards, such as board 307, can be fixedly disposed in parallel within the housing 302 progressively farther from battery 320. Further, according to exemplary configuration of FIG. 3, power button 310 or 210, indicator light 313 or 213, paring button 308 or 208, and jack 312 or 212 can be mounted through a side of housing 302 in a weatherproof configuration. Still further, according to an exemplary implementation, antenna 306 or 206 can be mounted in a weatherproof configuration onto a cover 301 which can be removably attached to housing 302, for example by screws 330, to provide selective access to the interior of housing 302. The design of the enclosure, as well as the sealing material applied between cover and housing, facilitate weatherproofing.

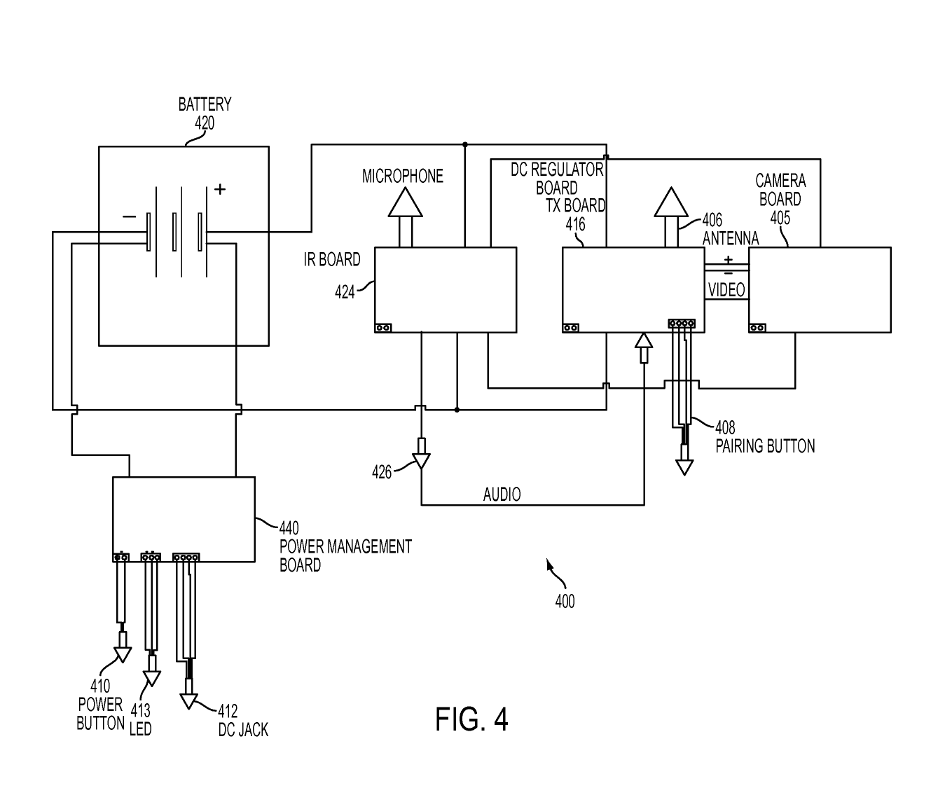

Referring to a block diagram of FIG. 4, according to an exemplary embodiment of the present invention and a camera-containing unit 400 can comprise, for example battery 420, IR board 424, power management board 440, TX board 406, and camera board 405. In the example of FIG. 4, power management board 440 interfaces with power button 410 which can provide ON/OFF control for unit 400, indicator light 413 which can provide ON/OFF indication, and jack 412 which can provide connection of a charger for battery 420. Battery 420 provides power to boards 424 and 406, which can be connected in parallel as shown. Camera board 405 can be configured to: receive power from IR board 424 as shown; interface with IR board 424 for infrared image and/or video processing; and interface with TX board 406 for camera control, and/or image and/or video transmission. IR board 424 can include an audio interface 426, and interface with TX board 406 for audio control, and/or audio transmission. TX board 406 can be configured with an interface 406 for connection to a wireless antenna, such as 106 or 306. TX board 406 can also be configured with an interface 408 for connection to a pairing controller, such as 108 or 208. Exemplary non-limiting specifications for battery and power Management board according to an embodiment of the present invention are as follows:
Lithium Ion 3s2p 18650, 10.8V, 5.8 Ah
2.9 Ah or 2450 mAh capacity
Minimum 4 hours of battery life.
Dimensions 70 mm×56 mm×38 mm
Connector to battery input/DC jack: CT-HC2pM JST B2B-ZR-PCB 2 pin male wire connector
Connector to LED: CT-HC3pM JST B3B-ZR-PCB 3 pin male wire connector
Connector to Power Button: CT-HC4pM B4B-ZR-PCB 4 pin male wire connector
Connector to battery output/IR board: CT-HC2 pF ZHR-2 female wire connector
Safety and power management board that includes the following functionality:
   a. Lithium Ion safety protection against over charge, over discharge, over current and short circuit.
   b. Protection against charging outside allowable temperature range: 0 C to 45 C
   c. Low voltage indicator at 9.6V—Red LED
   d. Charged indicator at 12.55V—Green LED
   e. Voltage cut off at 9V to avoid deep discharge
   f. Time off for discharge cycles, set at 15 minutes (adjustable: no time-off, 30 and 45 minutes)

Referring to FIG. 5, according to an exemplary implementation of embodiments of the present invention, antenna 500 or 306 includes body 550 configured to protrude out of a camera-containing unit housing, such as 102 or 302, or a housing cover such as 301. Wiring 558 can extend from body 550 to connect with TX board 406, 306 or 206, by connector 560. Antenna 500 can be mounted in a weatherproof configuration to a housing or housing cover by a threaded portion 552 extending into the housing or housing cover and affixed to the housing or housing cover by washer 554 and nut 556, as shown for example in FIG. 3 by exemplary mounting of antenna 306 to cover 301. Exemplary non-limiting specifications for a wireless antenna, including exemplary relative dimensions of FIG. 5, according to an embodiment of the present invention are as follows:
Frequency range: 2400-2500 MHz
Band width: 100 MHz
Vswr<=2.0
Gain: 3 dBi
Impedance: 50 ohm
Polarization: Vertical
Max. Power: 40 W
ABS, dimensions: 46 mm diameter, 16 mm in height
Cable: RG316—100 mm
Temperature range: −45 C to 85 C
Connector: MMCXJW

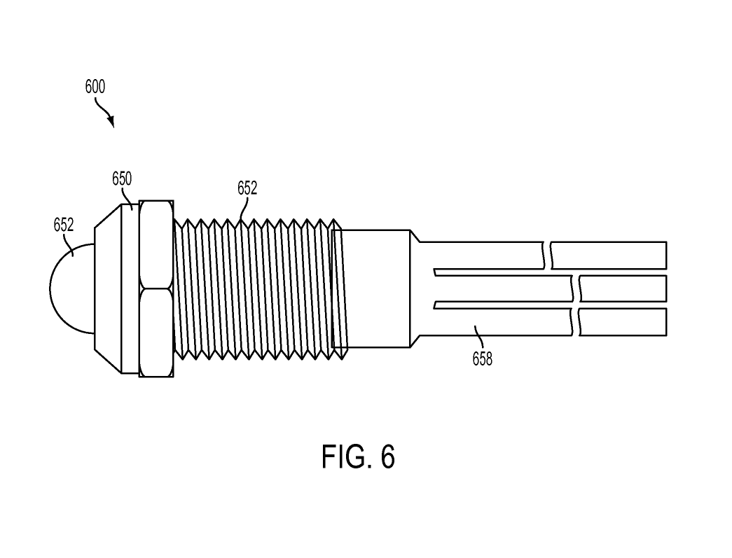

Referring to FIG. 6, according to an exemplary implementation of embodiments of the present invention, indicator light 600 (213 Or 313) includes body 650 configured to protrude out of a camera-containing unit housing, such as 102 or 302. The protruding portion includes a light source 652, such as an LED. Electric connection 658 can extend from body 650, for example to connect with power management board 440. Indicator light 600 can be mounted in a weatherproof configuration to a housing by a threaded portion 652 extending into the housing and affixed to the housing, for example by a washer and nut, as shown for example in FIG. 3 by exemplary mounting of indicator light 313 to housing 302. Exemplary non-limiting specifications for a wireless antenna, including exemplary relative dimensions of FIG. 6, according to an embodiment of the present invention are as follows:
Rate Current: 20 mA
Rate Voltage: 2˜200 VAC/DC
Insulation resistance: 100 Mohm (minimal)
Dielectric Strength: 1,000V RMS (minimal)
Humidity: under 85%
Withstand Voltage: ≧1000V 50/60 Hz Last for 1 min
Vibration: 10 to 55 Hz 1.5 double-amplitude
Dimensions: 8 mm diameter
Color: Green and Red
Green & Red common anode

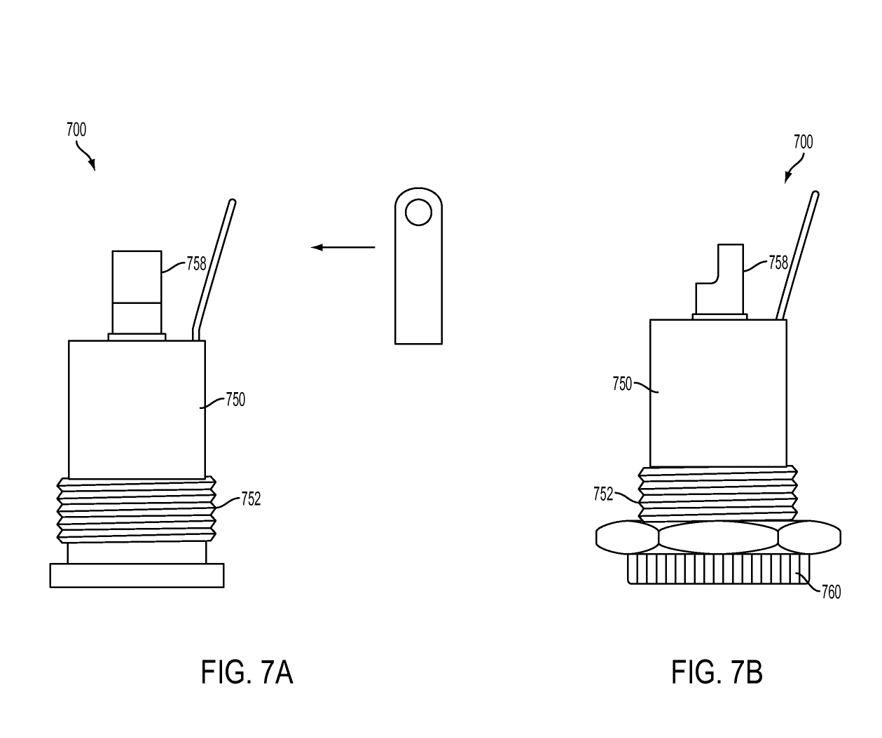

Referring to FIGS. 7A and 7B, according to an exemplary implementation of embodiments of the present invention, jack 700 (212 or 312) includes body 750 configured to protrude out of a camera-containing unit housing, such as 102 or 302 by a slightly protruding portion 760 which includes a charger access therein. Electrical connection 758 can extend from body 750, for example to connect with power management board 440. Jack 700 can be mounted in a weatherproof configuration to a housing by a threaded portion 752 extending into the housing and affixed to the housing, for example by a washer and nut, as shown for example in FIG. 3 by exemplary mounting of jack 312 to housing 302. Exemplary non-limiting specifications for a wireless antenna, including exemplary relative dimensions of FIG. 7A, according to an embodiment of the present invention are as follows:
14 mm round exterior
12 mm round threaded
18.2 mm depth into enclosure including power connector
Rubber insulator between enclosure and connector
Rubber plug for DC port

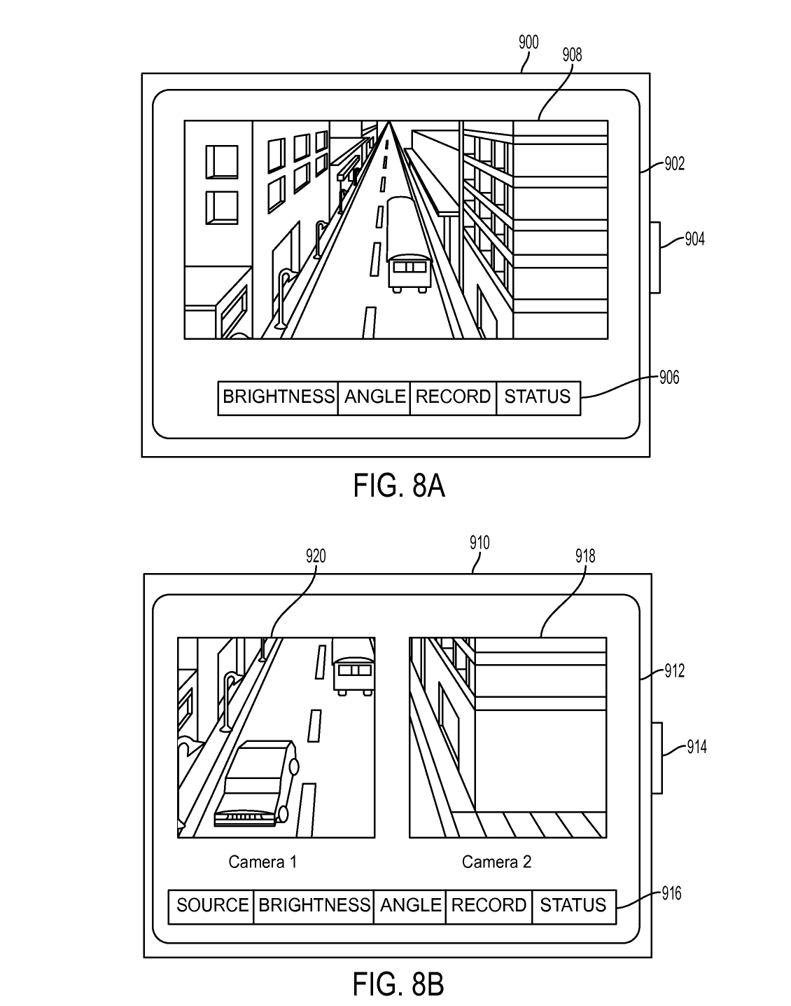

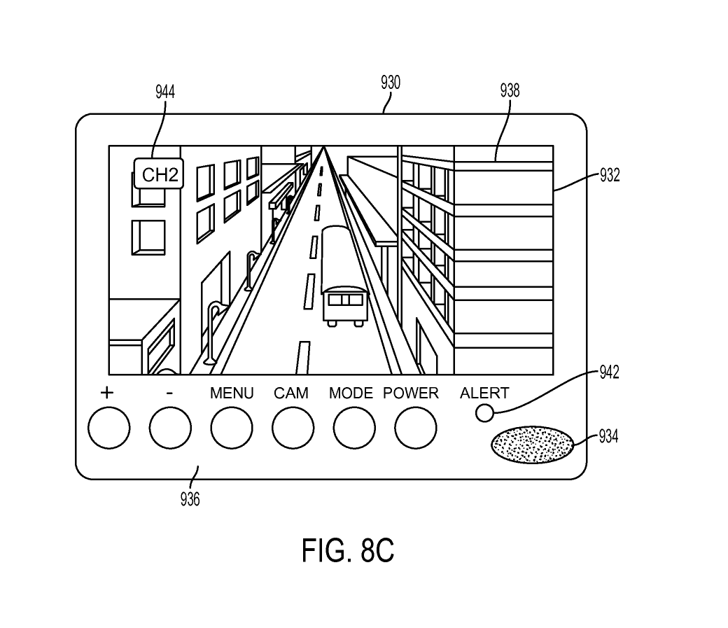

Exemplary embodiments of the present invention can implement GUI configurations as illustrated in FIG. 8A where monitor 900 is configured for pairing with a camera-containing unit such as 100, 200, 300 or 400, and outputs video and/or images 908 received from camera-containing unit on screen 902, and/or audio via speaker 904. Monitor 900 can also include controllers 906, such as for example touch screen controls, for transmitting commands to the paired camera-containing unit and/or modifying display on screen 902.

FIG. 8B illustrates another exemplary implementation of method and system according to exemplary embodiments of the present invention, where monitor 910 can be selectively paired with two or more camera-containing units such as 100, 200, 300 or 400 and selectively output on screen 912 video and/or images 918 received from one camera-containing unit and video and/or images 920 received from another camera-containing unit. In an exemplary implementation, audio from one of the paired camera-containing units can be selected, for example, by means of a “source” selection using controllers 916 for output via speaker 914. Similarly to controllers 906, controllers 916 can include for example touch screen controls, for transmitting commands to the paired camera-containing units and/or modifying display on screen 912. While FIG. 8B illustrates an exemplary implementation of two camera-containing units paired with monitor 910, it will be appreciated that any number of camera-containing units can be paired with monitor 910, for example provided such pairings can be supported by the communication protocols and monitor display configurations.

FIG. 8C illustrates yet another exemplary implementation of method and system according to exemplary embodiments of the present invention, where monitor 930 can be selectively paired with two or more camera-containing units such as 100, 200, 300 or 400 and selectively output on screen 932 video and/or images 938 received from one of the paired camera-containing unit, for example selected MODE button control panel 936. In an exemplary implementation, a pop-up window 944 can provide an indication as to the output of which camera-containing unit is currently being displayed on screen 932. As further illustrated in the example of FIG. 8C, according to exemplary embodiments of the present invention, monitor 930 can have an incorporated visual indicator 942, such as an LED that is green when the monitor is paired with a camera and flashes RED when the image from camera has been lost. In yet further exemplary implementation, in conjunction with visual indicator 942 (for example flashing RED), an audible alert can be provided via speaker 934. Both visual and audible alerts can serve as a warning to the driver that the communication has been lost or that camera-containing unit should be retrieved from the trailer. In further exemplary implementations visual indicator 942 and/or audio alert features can be provided for monitors 900 and 910.

Exemplary non-limiting specifications for a monitoring unit according to an embodiment of the present invention are as follows:
2.4 GHz Technology
7″ Monitor with Digital Panel
Resolution: 800*R.G.B*480
Power voltage: DC 12V-24V
Pairing indicator (flashes when paired, constant green light when successfully paired)
Flashing LED, or onscreen warning, for lost connection between camera-containing unit and receiver
Operating frequency: 2400-2483.5 MHz
Decompression form: MPEG 4
Emitting frequency: 18 dBm
Transmitting speed: 12 Mbps
Receiving Sensitivity: −78 dBm@ 1 MHZ 16QAM VR850/AV
Spread spectrum: frequency hopping
Hopping rate: 1200/S
Outer dimension: 182(L)×75(W)×124(H) mm
Brightness: 400 cd/m².
Viewing angle: U: 50°/D: 60°, R/L: 70°
Operating temperature: ˜−20° C. to ˜+70° C.
Storage temperature: ˜−30° C. to ˜+80° C. RH90%
Monitor brightness: ˜400 CD/M2
Speaker Output Level ˜82 dB

FIG. 9A illustrates video, image and/or audio monitoring system and method according to exemplary embodiments of the present invention where, for a tractor-trailer 900, one or more camera-containing units 906, 908 can be selectively mounted on trailer 910 and can be selectively paired with monitor 904 in cab 902. Images and/or video from one of units 906, 908 can be displayed as illustrated in the example of FIG. 8A on monitor 904 (900) when configured for pairing with one of the units 906 or 908. On the other hand, images from both units 906 and 908 can be displayed as illustrated in the example of FIG. 8B on monitor 904 (910) when configured for pairing with both units 906 and 908. Corresponding audio can be selectively output as described with reference to FIGS. 8A and 8B. In yet another exemplary implementation, images from units 906 and 908 can be displayed sequentially, or selectively, as illustrated in the example of FIG. 8C on monitor 904 (930) when configured for pairing with units 906 and/or 908.

FIG. 9B illustrates video, image and/or audio monitoring system and method according to other exemplary embodiments of the present invention where one or more camera-containing units 916, 918 of tractor 920, and one or more camera-containing units 926, 928 of tractor 930, can be selectively paired with monitor 914 in cab 912. For example, when cab 912 engages tractor 920, monitor 914 can selectively pair with one or both units 916, 918, and images and/or video from one or both units 916, 918 can be displayed on monitor 914, as illustrated in the example of FIGS. 8A, 8B and 8C, respectively. When cab 912 disengages from tractor 920 and engages tractor 930, monitor 914 can drop the pairing with units 916, 918, and selectively pair with one or both units 926, 928 so that images and/or video from one or both units 926 or 928 can now be displayed on monitor 914. On the other hand, images from one or more of all four units 916, 918, 926, 928 can be selectively displayed on monitor 914 as long as the pairing of respective units 916, 918, 926, 928 with monitor 914 is maintained. Once again, corresponding audio can be selectively output as described with reference to FIGS. 8A and 8B. In yet another exemplary implementation, images from units 916, 918, 926, 928 can be displayed sequentially, or selectively, as illustrated in the example of FIG. 8C on monitor 914 (930) when configured for pairing with units 916, 918, 926, and/or 928.

FIG. 9C illustrates video, image and/or audio monitoring system and method according to yet other exemplary embodiments of the present invention where one or more camera-containing units 966, 968 of tractor 960 can be selectively paired with monitor 944 in cab 942 and/or with monitor 954 in cab 952. For example, when cab 942 engages tractor 960, monitor 944 can selectively pair with one or both units 966, 968, and images and/or video from one or both units 966, 968 can be displayed on monitor 944, as illustrated in the example of FIG. 8A or 8B, respectively. When cab 942 disengages from tractor 960 and cab 952 engages tractor 960, monitor 954 can selectively pair with one or both units 966, 968, for example forcing monitor 944 to drop the pairing with one or both units 966, 968 now paired with monitor 954, so that images and/or video from one or both units 966 or 968 can now be displayed on monitor 954. In a case when both monitors 944 and 954 are paired with one or both units 966,968, a communication protocol can be provided to prioritize commands that may be issued from monitor 944 or 954 to units 966,968 to avoid conflict. Once again, corresponding audio can be selectively output as described with reference to FIGS. 8A and 8B. In yet another exemplary implementation, images from units 966 and 968 can be displayed sequentially, or selectively, as illustrated in the example of FIG. 8C on monitor 944 (930) and/or monitor 954 (930) when configured for pairing with units 966 and/or 968.

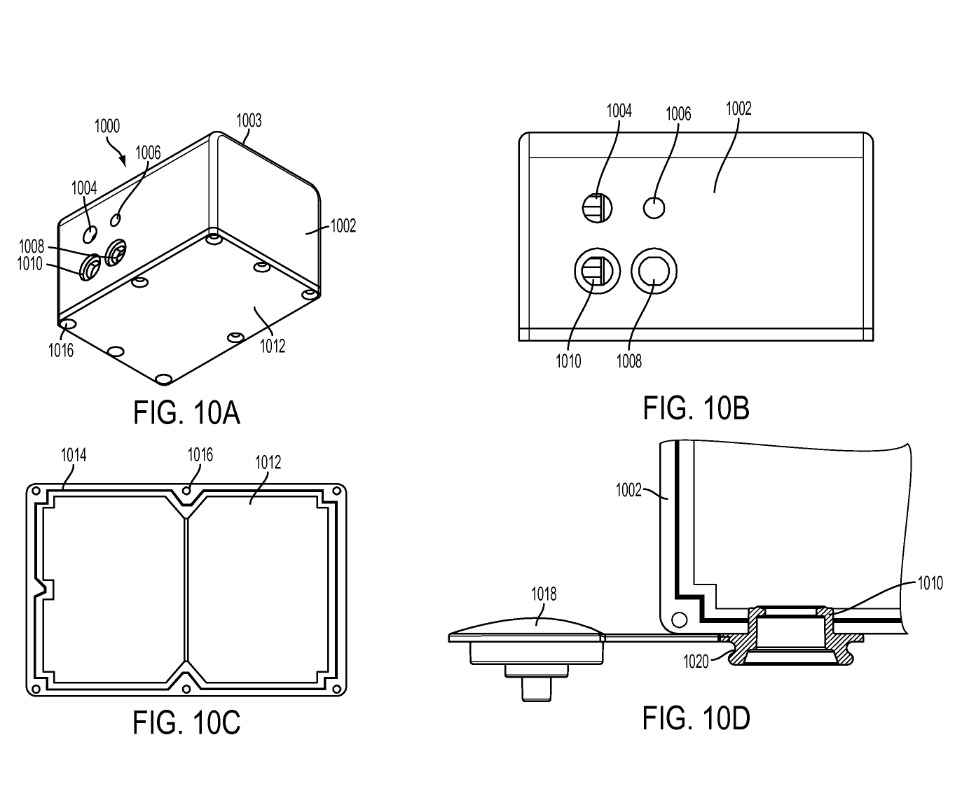

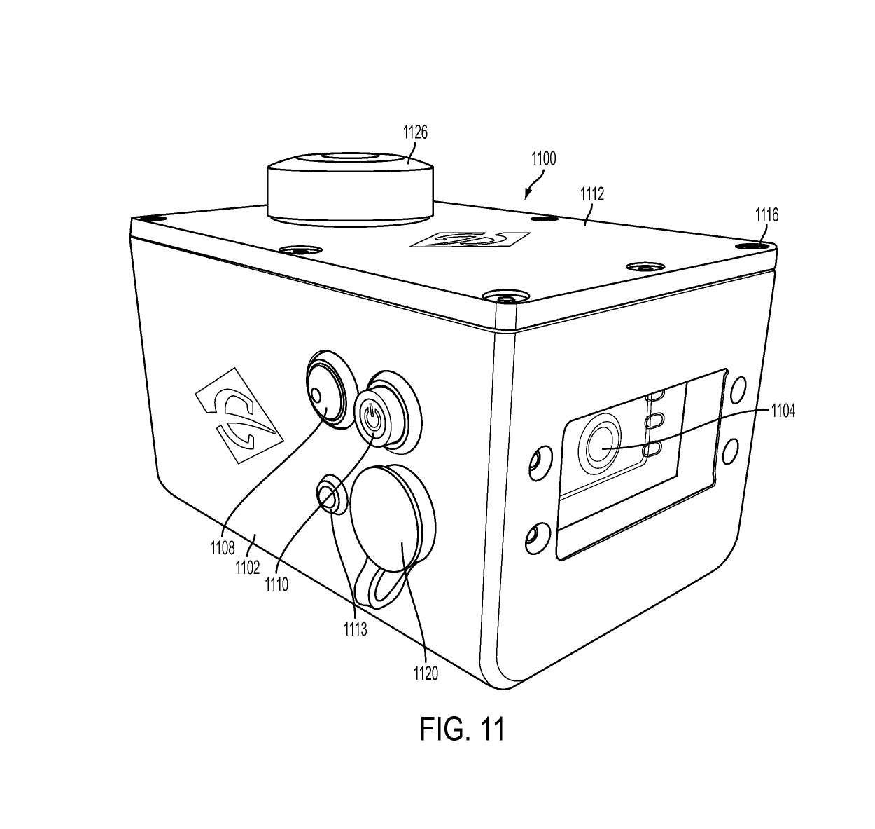

FIG. 10A illustrates an exemplary structure of housing 1000 for camera-containing unit, such as 200, 300 or 400, according to embodiments of the present invention. Housing 1000 can comprise an essentially rectangular box including wall 1002 which can be formed as a continuous structure or assembled, for example as four individual side pieces, bottom 1003 which can be formed integrally with walls 1002 or a as separate attached structure, and cover 1012 which can be permanently or removably attached to wall 1002, for example using screws engaging wall 1002 via openings 1016. A portion of wall 1003 includes receptacles 1004, 1005, 1008 and 1010 for receiving therein components such as power button 310 or 210, indicator light 313 or 213, paring button 308 or 208, and jack 312 or 212, which can be mounted through respective receptacles 1004, 1005, 1008 and 1010 of housing 1000 in a weatherproof configuration as shown, for example in FIG. 3. FIG. 10B shows a side view of a portion of wall 1002 containing receptacles 1004, 1005, 1008 and 1010, and provides relative measurements of the wall structure as illustrative, non-limiting, example. FIG. 10C shows in more detail structure of cover 1012 providing relative measurements of the cover structure as illustrative, non-limiting, example. According to an exemplary implementation, cover 1012 can accommodate an O-ring 1014 interposed between surface of cover 1012 facing interior of housing 1000 and top of wall structure 1002 engaging cover 1012. O-ring 1014 can comprise flexible material to facilitate weatherproofing of housing 1000 when cover 1012 is secured to wall 1002. FIG. 10D shows an exemplary implementation of embodiment of the present invention where a seal 1020 including a cover 1018 is configured in receptacle 1010 of wall 1002 as a weatherproofing measure, for example for jack 312 or 212.

Referring to FIG. 11, according to an exemplary embodiment of the present invention components of a camera-containing unit 1111 can be arranged within housing 1102 with a cover 1112 attached to housing 1102, for example by screws 1116, where all of the components, such as those illustrated in FIG. 3, are weatherproofed within housing 1102 under cover 1102. Further, according to exemplary configuration of FIG. 11, power button 1110 (310 or 210), indicator light 1113 (313 or 213), paring button 1108 (308 or 208), and jack (312 or 212) under cover 1120 (1020, 1018) can be mounted through a side of housing 1102 in a weatherproof configuration. Still further, according to an exemplary implementation, antenna 1126 (306 or 206) can be mounted in a weatherproof configuration onto a cover 1112 (301) which can be removably attached to housing 11032 (302), for example by screws 1116 (330), to provide selective access to the interior of housing 1102 (302). Further, camera 1104 can be arrange inside the housing 1102 under a transparent weatherproof cover or window, as shown in the non-limiting example of FIG. 11 where a transparent window is disposed in the side of housing 1102. As noted previously, the design of the enclosure, as well as the sealing material applied between cover 1112 and housing 1102, facilitate weatherproofing

The above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and so on, including a carrier wave transmitting signals specifying the program instructions, data structures, and so on. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

While the present invention has been shown and described with reference to certain exemplary embodiments thereof, it will be understood by those skilled in the art that various changes in form and details may be made therein without departing from the spirit and scope of the present invention as defined by the appended representative claims.

I claim:

1. A monitoring system for tractor-trailer vehicles, the system comprising:
a first camera-containing unit configured for wireless communication and comprising a first wireless transceiver, a first image processor, and a first rechargeable power source powering at least said first wireless transceiver and said first image processor;
a first monitoring unit configured for wireless communication and comprising a first display selectively outputting first image data based on first wireless communication from said first camera-containing unit;
a first trailer having said first camera-containing unit removably attached to an exterior surface of said first trailer; and
a first tractor having said first monitoring unit positioned in a cab of said first tractor for viewing of said first image data,
wherein said first monitoring unit and said first camera-containing unit establish said first wireless communication by pairing said first monitor unit with said first camera-containing unit.

2. The system of claim 1, wherein said first camera-containing unit further comprises:
a first housing having at least said first wireless transceiver, said first image processor, and said first rechargeable power source disposed in said first housing; and
a first magnetic structure disposed on an exterior of said first housing for removably attaching said first housing to said first trailer.

3. The system of claim 1, wherein said first image data comprises at least one of streaming video and one or more still images.

4. The system of claim 1, further comprising a second camera-containing unit configured for wireless communication and comprising a second wireless transceiver, a second image processor, and a second rechargeable power source powering at least said second wireless transceiver and said second image processor,
wherein said first trailer has said second camera-containing unit removably attached to said exterior surface of said first trailer at a location different from said first camera-containing unit,
said first monitoring unit and said second camera-containing unit establish second wireless communication by pairing said first monitor unit with said second camera-containing unit, and
said first display of said first monitoring unit selectively outputs at least one of:
said first image data based on said first wireless communication from said first camera-containing unit,
second image data based on said second wireless communication from said second camera-containing unit, and
said first image data and said second image data.

5. The system of claim 4, wherein:
at least one of said first camera-containing unit and said second camera-containing unit further comprises an audio processor;
said first monitoring unit comprises a sound output selectively outputting audio data based on first wireless communication from said first camera-containing unit or based on second wireless communication from said second camera-containing unit.

6. The system of claim 1, wherein said first monitoring unit further comprises a first controller outputting first commands to least said first camera-containing unit via said first wireless communication to control operation of said first camera-containing unit.

7. The system of claim 6, wherein said first monitoring unit further comprises a first user interface, said controller outputting said first commands based on input received via said first user interface.

8. The system of claim 7, wherein said controller controls said selective output of at least said first image data on said first display based on content of at least one of said first wireless communication and said input received via said first user interface.

9. The system of claim 1, further comprising:
a second camera-containing unit configured for wireless communication and comprising a second wireless transceiver, a second image processor, and a second rechargeable power source powering at least said second wireless transceiver and said second image processor; and
a second trailer having said second camera-containing unit removably attached to an exterior surface of said second trailer;
wherein said first monitoring unit and said second camera-containing unit establish second wireless communication by pairing said first monitoring unit with said second camera-containing unit,
at least one of said first wireless communication and said second wireless communication being selectively or automatically maintained or discontinued; and
said first display of said first monitoring unit selectively outputs at least one of:
said first image data based on said first wireless communication from said first camera-containing unit,
second image data based on said second wireless communication from said second camera-containing unit, and
said first image data and said second image data.

10. The system of claim 9, wherein at least one of said first wireless communication and said second wireless communication is selectively or automatically maintained or discontinued based on distance between said first tractor and at least one of said first trailer and said second trailer.

11. The system of claim 1, further comprising:
a second monitoring unit configured for wireless communication and comprising a second display selectively outputting first image data based on second communication from said first camera-containing unit; and
a second tractor having said second monitoring unit positioned in a cab of said second tractor for viewing of said first image data,
wherein said second monitoring unit and said first camera-containing unit establish said second wireless communication by pairing said second monitoring unit with said first camera-containing unit, and
at least one of said first wireless communication and said second wireless communication being selectively or automatically maintained or discontinued.

12. The system of claim 11, wherein at least one of said first wireless communication and said second wireless communication is selectively or automatically maintained or discontinued based on distance between said first trailer and at least one of said first tractor and said second tractor.

13. A self-contained wireless imaging device comprising:
a wireless transceiver;
an image processor;
a rechargeable power source powering at least said wireless transceiver and said image processor;
a weatherproof housing having at least said wireless transceiver, said image processor, and said rechargeable power source disposed in said weatherproof housing;
a camera including a lens system capturing data comprising at least one of video and one or more still images exterior to said weatherproof housing, said camera outputting said captured data to said image processor, said image processor outputting processed captured data to said wireless transceiver; and
a magnetic structure disposed on an exterior of said weatherproof housing for removably attaching said first housing to a surface of an object.

14. The device of claim 13, further comprising a weatherproof connection providing access to said power source through said housing for selectively charging said power source.

15. The device of claim 13, further comprising a controller mounted to said housing, accessible externally of said housing, and in communication with said wireless transceiver,
wherein manipulation of said controller selectively initiates a wireless pairing operation with another wireless device.

16. The device of claim 13, further comprising an indicator mounted to said housing and comprising a light source visible externally of said housing, said indicator being in communication with at least one of said wireless transceiver, said image processor, said rechargeable power source, and said camera,
wherein said light source produces a light output indicative of a status of at least one of said wireless transceiver, said image processor, said rechargeable power source, and said camera.

17. The device of claim 13, further comprising a solar panel mounted on an exterior of said housing for charging said rechargeable power source.

18. A monitoring method for tractor-trailer vehicles, the method comprising:
attaching to an exterior surface of a first trailer a first camera-containing unit configured for wireless communication and comprising a first wireless transceiver, a first image processor, and a first rechargeable power source powering at least said first wireless transceiver and said first image processor;
placing in a cab of a first tractor a first monitoring unit configured for wireless communication and comprising a first display selectively outputting first image data based on first wireless communication from said first camera-containing unit; and
establishing said first wireless communication by pairing said first monitor unit with said first camera-containing unit.

19. The method of claim 18, further comprising:
attaching to said exterior surface of said first trailer, or to an exterior surface of a second trailer, a second camera-containing unit configured for wireless communication and comprising a second wireless transceiver, a second image processor, and a second rechargeable power source powering at least said second wireless transceiver and said second image processor;
establish second wireless communication by pairing said first monitor unit with said second camera-containing unit; and
selectively outputting on said first display of said first monitoring unit at least one of:
said first image data based on said first wireless communication from said first camera-containing unit,
second image data based on said second wireless communication from said second camera-containing unit, and
said first image data and said second image data.

20. The method of claim 18, further comprising:
placing in a cab of a second tractor a second monitoring unit configured for wireless communication and comprising a second display selectively outputting first image data based on second communication from said first camera-containing unit;
establish said second wireless communication by pairing said second monitoring unit with said first camera-containing unit; and
selectively or automatically maintaining or discontinuing at least one of said first wireless communication and said second wireless communication.
